(19) United States
(12) Patent Application Publication
(10) Pub. No.: US 2024/0198875 A1
(43) Pub. Date: Jun. 20, 2024

(54) SEATING GROUP WITH SEATS FOR ADJUSTING A SEAT DEPTH AND A LUMBAR SUPPORT

(71) Applicant: GRAMMER Aktiengesellschaft, Ursensollen (DE)

(72) Inventors: Thomas PÖLLINGER, Regensburg (DE); Christopher NEIDL, Schmidgaden (DE)

(73) Assignee: GRAMMER Aktiengesellschaft, Ursensollen (DE)

(21) Appl. No.: 18/502,840

(22) Filed: Nov. 6, 2023

(30) Foreign Application Priority Data
Dec. 15, 2022 (DE) 10 2022 133 439.2

(51) Int. Cl. B60N 2/66; B60N 2/01

(52) U.S. Cl. CPC B60N 2/66; B60N 2/01

(57) ABSTRACT

A seating group comprising a first seat and a second seat arranged side by side and each adjustable in seat depth and lumbar support, each comprising a seat part and a backrest part. It may be provided that the first seat and the second seat are each formed and provided for simultaneous adjustment of a seat depth and a lumbar support, wherein the seating group is formed such that the first seat and the second seat are adjustable independently of each other in the respective seat depth and lumbar support.

### CROSS REFERENCE TO RELATED APPLICATION

This application claims the benefit of German Patent Application No. 10 2022 133 439.2, filed Dec. 15, 2022, the contents of which are incorporated herein by reference in its entirety.

### FIELD

The present invention relates to a seating group comprising a first seat and a second seat, which are arranged side by side, for simultaneous adjustment of the seat depth and the lumbar support of each seat.

### BACKGROUND

For example, DE 10 2014 118 061 A1 is known from the prior art, which shows a seat depth adjustment and a simultaneous lordosis or kyphosis support for the lower back. The vehicle seat has a seat part which has a strap element arranged in the rear section which, when the seat part is pushed forwards, deforms sheet-metal spring elements, and thus adjusts the support of the lumbar section to the back of a person sitting on it.

The vehicle seat shown in the prior art has the disadvantage that the seat part tends to be pushed back again, due to the elastic deformation of the spring sheet metal elements. Likewise, a structurally complex design of the vehicle seat is provided.

### SUMMARY

It is therefore the object of the present invention to specify a seating group with several seats for simultaneous and, with regard to the seats, independent adjustment of a seat depth and a lumbar support, which is of particularly simple design and overcomes the disadvantages of the prior art.

The underlying object is solved by a vehicle seat with the features of claim 1.

According to the invention, it is a core idea of the present invention to provide a seating group comprising a first seat and a second seat, which can be arranged side by side and are each adjustable in seat depth and lumbar support and each comprise a seat part and a backrest part. Further according to the invention, it is provided that the first seat and the second seat are each configured and provided for simultaneous adjustment of a seat depth and a lumbar support, wherein the seating group is configured in such a way that the first seat and the second seat are independently adjustable in relation to the seat depth and lumbar support.

It is noted that explanations regarding the performance of a seat may refer to both seats. When general or generalized terms are used, each seat or both seats may be understood in an alternative or cumulative manner, respectively.

Accordingly, the first seat comprises a first seat part and a first backrest part, and the second seat comprises a second seat part and a second backrest part.

Preferably, the respective seat part comprises the respective seat part frame. Further preferably, a respective seat part upholstery may be provided, on which the person may sit.

According to the invention, it is provided that the first seat is independently adjustable in its seat depth and lumbar support and the second seat is independently adjustable in its seat depth and lumbar support, that is, a seat depth adjustment of the first seat is independent of the seat depth adjustment of the second seat and vice versa.

The seats are therefore provided for simultaneous adjustment of a seat depth and a lumbar support.

According to a preferred embodiment, it may be provided that the first seat comprises a first backrest frame, a first seat part frame and a first connecting frame, wherein the first connecting frame is rotatably connected via a first rotation axis to the first backrest frame and rotatably connected via a second rotation axis to the first seat part frame and connecting the first seat part frame to the first backrest frame, wherein the first seat part frame and the first fist backrest frame are connected to a first supporting element in such a way that the first seat part frame and the first fist backrest frame are simultaneously displaceable in relation to the first supporting element.

Alternatively or cumulatively, the second seat may comprise a second backrest frame, a second seat part frame, and a second connecting frame, wherein the second connecting frame being rotatably connected via a third rotation axis to the second backrest frame and rotatably connected via a fourth rotation axis to the second seat part frame and connecting the second seat part frame to the second backrest frame, wherein the second seat part frame and the second backrest frame are connected to a second supporting element such that the second seat part frame and the second backrest frame are simultaneously displaceable in relation to the second supporting element.

Particularly preferably, the first supporting element and the second supporting element are arranged stationarily, for example stationary in relation to a cabin, a floor or the like.

If a person who is sitting on the respective seat wishes to adjust the seat depth, the person can manually move the seat part either forward or backward until the correct seat depth is set for the respective person.

When adjusting a seat depth, according to one embodiment, it may be provided that along with the seat part frame, the backrest frame is also displaced with respect to the support element. Accordingly, the connecting frame, which is arranged between the backrest frame and the seat part frame, namely rotatably arranged, is also displaced correspondingly with the seat part frame and pulls the backrest frame accordingly when the seat part frame is displaced.

Due to the forced guidance of the connecting frame with respect to the seat part frame and the backrest frame, the position or arrangement of the connecting frame in space changes, namely to the effect that a lower portion of the connecting frame is displaced forward or backward correspondingly with the seat part frame.

By changing the position of the connecting frame in space, as shown above, this changes the lumbar support of the vehicle seat.

The connecting frame can therefore also be referred to as a lumbar support frame, which is formed and arranged in such a way that the connecting frame can provide support for the lumbar region of a person.

By the indicated supporting element it can be understood, for example, that it can be a rigid seat shell which is formed in such a way that the seat part frame and the backrest frame can be attached thereto, namely in such a way that a displacement of the seat part frame and the backrest frame with respect to the supporting element is possible.

Particularly preferably, according to one embodiment, it may be provided that the first supporting element and the second supporting element are rigidly connected to each other, so that the first supporting element and the second supporting element form a common supporting element.

Rigidly connected may mean here that the first supporting element and the second supporting element may be formed jointly or in one piece to form the common supporting element. The common supporting element therefore has the function of supporting both seats, and that the seat parts are displaceable in relation to the common supporting element.

Particularly preferably, the common supporting element is arranged stationarily, that is, in particular stationary with respect to a cabin or a rail wagon or the like.

According to a particularly preferred embodiment, it is provided that the connection of the seat part frame and the backrest frame to the support element is such that the backrest frame and the seat part frame are each displaceable exclusively translationally in relation to the support element. This means preferably that the first backrest frame and the first seat part frame are each exclusively translationally displaceable and that the second backrest frame and the second seat part frame are each exclusively translationally displaceable.

This means that when the seat part frame is moved forward or backward, the backrest frame can be moved upward or downward accordingly. The translational displacement of the seat part frame and the backrest frame therefore provides and executes a forced guidance of the connecting frame.

Hereby, a particularly good guidance of the connecting frame can be achieved in order to adjust the lumbar support of the vehicle seat as precisely and easily as possible.

According to a further preferred embodiment, it can be provided that the seat part frame and the backrest lumbar support frame enclose a fixed and unchangeable angle to one another. This may advantageously allow the angle of the person between the upper region of the back and the buttocks to remain unchanged, so that further particularly advantageous adjustment is possible in the lumbar region of the back.

According to a further particularly preferred embodiment, it may be provided that a first variable angle is provided between the first seat part frame and the connecting frame and a second variable angle is provided between the backrest frame and the connecting frame.

Further preferably, it is provided that the size of the variable angles changes when the seat part frame is displaced, whereby the lumbar support or the adjustment of the lumbar support is variable.

This makes it possible for the arrangement of the connecting frame to the seat part frame and the backrest frame to provide good adjustment of the lower back and the lumbar support, respectively.

According to a further preferred embodiment, it may be provided that the backrest frame and the seat part frame are each translationally displaceable by means of guide means. It is further preferred that the guide means can be at least one sliding block guide.

If the guide means is a sliding block guide, it is particularly advantageous that sliding block elements and slots are provided. Particularly advantageously, the sliding block elements are connected to the support element and the slots are integrated into the seat part frame and the backrest frame. This has the particular advantage that the corresponding frames can be hooked in during assembly of the vehicle seat.

Particularly advantageously, it is provided that the sliding block elements are formed at least partially complementary to the slots, so that the sliding block elements can be guided in the slots.

The guiding means can be formed in a particularly simple and structurally advantageous manner if one of the sliding block elements or each sliding block element comprises a first section, a second section and a third section, wherein the first section is arranged above the slot and is formed wider than the slot, and wherein the second section is connected to the first section and extends through the corresponding slot and a third section is arranged below the slot and is connected to the second section, wherein the third section is also formed wider than the slot.

The sliding block element thus preferably has a layered structure formed by the first section, the second section and the third section, which are arranged one above the other in a height direction. By the fact that preferably the second section can be guided in the slot and the first section and the third section are formed wider than the slot, a loosening of the sliding block and the slot can be prevented.

Particularly preferably, the slot or the slots have a mounting section which is formed and provided for the first section to be guided through this mounting section so that the second section can then projected through the slot. Preferably, the mounting section is dimensioned such that the first section can be passed therethrough.

The slot is held by the first section and the third section, so that the sliding blocks can be well prevented from falling out of the slot.

Particularly preferably, the position of the mounting section or the displacement of the seat part is such that in an assembled state of the vehicle seat, that is, that the seat part is mounted on the seat part frame, the sliding block cannot be passed through to the mounting section so as to be able to prevent the sliding block from falling out of the slot.

According to a further preferred embodiment, it may be provided that the backrest frame and the connecting frame are connected to a first upholstery element and the seat part frame is connected to a second upholstery element. It is particularly preferred that the first upholstery element is independent of the second upholstery element. This means that the first upholstery element and the second upholstery element are separate elements and are not connected to each other.

The fact that the upholstery elements are independent of each other, means that a deformation of the upholstery element can be reduced by the displacement of the seat part frame and the corresponding displacement of the backrest frame and the connecting frame, so that the durability and usability of the upholstery elements can be increased overall. Likewise, the first upholstery element in particular can better adapt to the conditions and position of the connecting frame.

Likewise, the independence of the upholstery elements can facilitate the assembly of the vehicle seat, since the seat part with the seat part frame can be assembled independently of the backrest frame and, during assembly, a connection can then be easily established through the connection between the seat part frame and the connecting frame.

According to a further preferred embodiment, it may be provided that there is a releasable connection between the seat part frame and the connecting frame for improved installation. Further preferably, the releasable connection is a clip connection.

Particularly preferably, according to a further preferred embodiment, it may be provided that the releasable connection comprises a sleeve element and a shaft piece insertable into the sleeve element. Preferably, the sleeve element can be formed in such a way that in a cross-section the sleeve element represents a circular sector with a center angle of more than 180° and 300° at most. Further preferably, it may be provided that the shaft piece is formed at least partially complementary to the sleeve element and may be inserted into the sleeve element.

At least partially complementary here refers in particular to an inner section of the sleeve element. In particular, the sleeve element has an outer and an inner delimitation, the inner boundary delimitation the interior of the sleeve element.

Particularly preferably, the sleeve element is formed of an elastically deformable material, so that the shaft piece can be easily inserted into the sleeve element, since the shaft piece is complementary to the interior of the sleeve element and therefore the opening of the sleeve element must be slightly widened in order to be able to clip the shaft piece into the sleeve element.

According to a further preferred embodiment, it can be provided that for displacing the first seat part or the first seat part frame, a first adjusting element is provided which is formed to displace the first seat part in a displacement direction, and wherein cumulatively or alternatively for displacing the second seat part or the second seat part frame, a second adjusting element is provided which is formed to displace the second seat part in the displacement direction.

By providing two adjustment elements, one for each seat, the seat depths and the lumbar support can be adjusted or adapted independently of each other.

The displacement direction can be, for example, a seat longitudinal direction. Likewise, the displacement direction can be understood as starting from the backrest towards the front or towards the rear.

According to a further preferred embodiment, it can be provided that the first adjusting element is connected to the first seat part frame and the first supporting element and the second adjusting element is connected to the second seat part frame and the second supporting element. Particularly preferably, the adjusting elements are arranged below the seat upholstery, viewed in the height direction. Overall, this results in a space-saving and secure arrangement.

According to a particularly preferred embodiment, it can be provided that the first adjusting element and the second adjusting element are connected to a single control unit, the control unit being provided and formed to control the adjusting elements independently of one another.

By providing a single or exactly one control unit, the space requirement and the manufacturing costs can be further reduced. The control unit is provided and designed to control the adjusting elements independently of one another, so that the seat depth adjustment and the lumbar support of the two seats can be made independent of one another.

Further, according to a preferred embodiment, the space requirement can be further reduced if it is provided that the control unit is arranged below the first seat part frame and below the second seat part frame as well as between the first adjusting element and the second adjusting element.

Further configurations and forms in the embodiments among each other are applicable to the further executions and are freely combinable among themselves, provided that they do not correspond to opposite embodiments.

Further advantageous embodiments are apparent from the subclaims.

Further objects, advantages and the usefulness of the present invention will be found in the following description in connection with the drawings.

The invention is described in more detail below in connection with the figures.

### BRIEF DESCRIPTION OF THE DRAWINGS

The Figures Show:

FIG. 1A Seating group according to one embodiment in a basic position;

FIG. 1B Seating group of FIG. 1A with a seat in a displaced position;

FIG. 1C Seating group of FIG. 1A with upholstered elements;

FIG. 1D Seating group of FIG. 1C in a side view;

FIG. 2A seating group in a side view in the basic position;

FIG. 2B Seating group of FIG. 2A in a sectional view;

FIG. 2C Seating group with at least one displaced seat in a side view;

FIG. 2D Seating group of FIG. 2C in a sectional view;

FIG. 3 Seating group with further components;

FIG. 4 Seating group of FIG. 3 in a partial exploded view;

FIG. 5A-5D Representation of the components.

### DETAILED DESCRIPTION

In the figures, the same components are each to be understood with the corresponding reference signs. For the sake of clarity, components may not be marked with a reference sign in some figures but have been designated elsewhere.

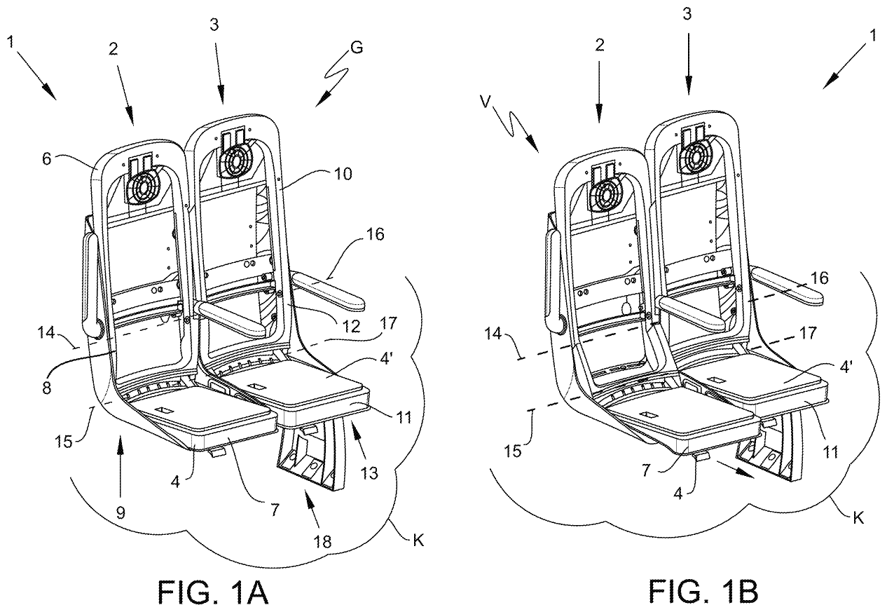

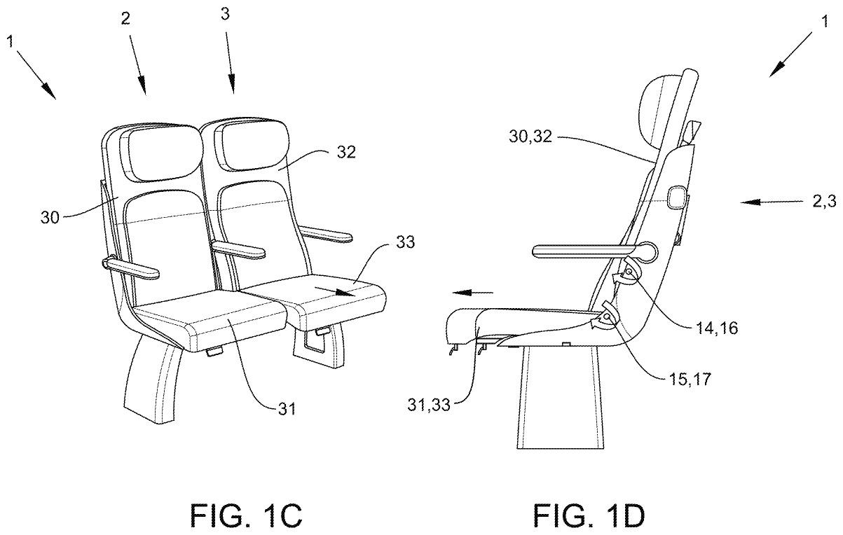

FIG. 1A shows a seating group 1 comprising a first seat 2 and a second seat 3, which are arranged side by side as viewed in a width direction B. The following explanations and elucidation apply with respect to each of the seats 2, 3.

As can be seen, the first seat 2 comprises a first fist backrest frame 6, a first seat part frame 7 and a first connecting frame 8, the first fist backrest frame 6 and the first connecting frame 8 being rotatably connected to each other via a first rotation axis 14. Further, the first connecting frame 8 is also rotatably connected to the seat part frame 7 via a second rotation axis 15.

Further, a first supporting element 9 is shown which is stationary and rigidly connected thereto with respect to a vehicle or cabin K. The first backrest frame 6, the first seat part frame 7 and the connecting frame 8 are thereby connected to the first supporting element 9. The connection between the first frames 6, 7, 8 and the first supporting element 9 is such that the first frames 6, 7, 8 can be displaced in relation to the first supporting element 9.

Preferably, the first supporting element 9 has a first backrest section 25 and a seat part section 26, wherein the first backrest section 25 is connectable or connected to the first backrest frame 6 and the first seat part section 26 is connectable or connected to the first seat part frame 7.

One or more armrests 27 may be arranged on the first supporting element 9, in particular on the first backrest section 25.

As can also be seen, the second seat 3 comprises a second backrest frame 10, a second seat part frame 11 and a second connecting frame 12, the second backrest frame 10 and the second connecting frame 12 are rotatably connected to each other via a third axis of rotation 16. Further, the second connecting frame 12 is also rotatably connected to the second 11 via a fourth rotation axis 17.

Further, a second supporting element 13 is shown which is stationary with respect to a vehicle or a cabin K and rigidly connected thereto. The second backrest frame 10, the second seat part frame 11 and the second connecting frame 12 are thereby connected to the second supporting element 13. The connection between the second frames 10, 11, 12 with the second supporting element 13 are thereby such that the second frames 10, 11, 12 are displaceable relative to the second supporting element 13.

Preferably, the second supporting element 13 comprises a second backrest section 28 and a second seat part section 29, wherein the second backrest section 28 is connectable or connected to the second backrest frame 10 and the second seat part section 29 is connectable or connected to the second seat part frame 11.

One or more armrests 27 can be arranged on the second supporting element 13, in particular on the second backrest section 28.

The first supporting element 9 and the second supporting element 13 together form a common supporting element 18, the first supporting element 9 and the second supporting element 13 are joined or connected to each other in one piece.

The seats 2, 3 according to FIG. 1A are shown in a basic position G, that is to say, that a respective seat part 4, 4′ is present in its initial position, thus has not yet been displaced forwards. The position in which the respective seat part frame 7, 11 is in its most rearward position is defined as the basic position G.

In FIG. 1B, one of the two seats 2, 3 is now shown in a displaced position V, specifically the first seat 2, that is, the first seat part 4 and the seat part frame 7, respectively, are displaced forward, represented by the corresponding arrow. By connecting the first backrest frame 6, the seat part frame 7 and the connecting frame 8, in accordance with the forward displacement of the first seat part frame 7, the backrest frame 6 is correspondingly moved downward, also shown by the corresponding arrow, and the connecting frame 8 is moved forward in the area of the second rotation axis 14 with the seat part frame 7 and downward in the area of the first rotation axis 14 with the first backrest frame 6.

As can be seen in FIG. 1B, the seat depth has been adjusted by moving the first seat part frame 7 forward and the lumbar support of the seat 2 has also been adjusted by the forced guidance of the first connecting frame 8.

In FIG. 1C, the seating group 1 is shown again according to FIGS. 1A and 1B, respectively, wherein a first upholstery element 30 and a second upholstery element 31 for the first seat 2 and a third upholstery element 32 and a fourth upholstery element 33 can be seen, wherein the first upholstery element 30 is connected to the first backrest frame 6 and the first connecting frame 8. The second upholstery element 31 is connected to the seat part frame 7. In particular, the upholstery elements 30, 31 are independent of each other, that is, there is no operative connection between the two upholstery elements 30, 31. However, the upholstery elements 30, 31 may contact each other, but are independent of each other in terms of movement and embodiment. Further, the third upholstery element 32 is connected to the second backrest frame 10 and the second connecting frame 12. The fourth upholstery element 33 is connected to the seat part frame 11. In particular, the upholstery elements 32, 33 are independent of each other, which means that there is no functional connection between the two upholstery elements 32, 33. However, the upholstery elements 32, 33 may contact each other, but are independent of each other in terms of movement and embodiment.

In FIG. 1D, the vehicle seat 1 is shown in a side view, with the basic position G on the one hand and the displaced position V on the other hand. By comparing the two positions G, V, it is easy to see on the one hand how the seat depth of the seat part 4, 4′ or seat part frame 7, 11 and on the other hand how the lumbar support has been adjusted by means of the connecting frame 8, 12.

It is also the case that the first rotation axis 5 is always arranged above the second rotation axis 6. In this case, the rotational axes 5, 6 are arranged in such a way that the area between the rotational axes 5, 6 corresponds to the lumbar region of a person. The same applies to the connecting frame 4. The same applies to the third rotation axis 16 and the fourth rotation axis 17.

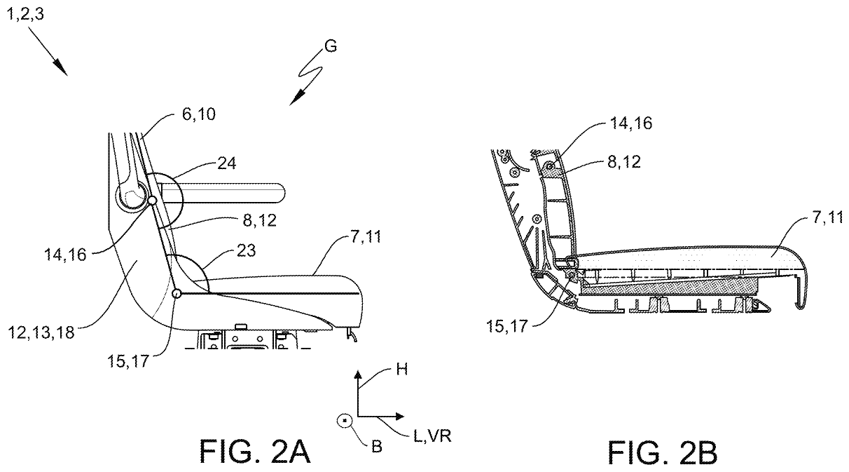

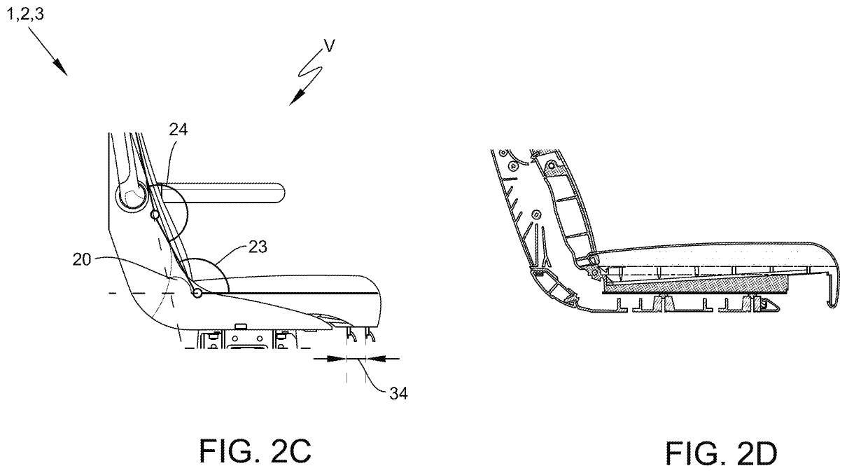

In the following FIGS. 2A to 2D, various positions of the seats 2, 3 are shown.

The respective FIGS. 2A to 2D are shown either in a side view or in a sectional view.

FIG. 2A shows the seat 2, 3 in its basic position G, that is the respective seat part frame 8, 12 or the seat part 4, 4′ is arranged in its rearmost position. The seat part frame 8, 12 and the backrest frame 6, 10 can be displaced exclusively translationally in relation to the support element 12, 13, 18. In particular, this means that the backrest frame 6, 10 and the seat part frame 7, 11 can be moved in their direction of extension, which corresponds to the longitudinal direction L and the displacement direction VR, respectively.

It is further provided that a fixed and unchangeable angle 22 is formed between the back-rest frame 6, 10 and the seat part frame 7, 11. Further, a second variable angle 24 is formed between the backrest frame 6, 10 and the connecting frame 8, 12 and a first variable angle 23 is formed between the connecting frames 8, 12 and the seat part frame 7, 11. These variable angles 23, 24 change depending on the position of the seat part frame 7, 11 and correspondingly of the backrest frame 6, 10.

In FIG. 2B, the vehicle seat according to FIG. 2A is shown in a sectional view.

FIG. 2C shows a displaced position V of one or both seats 2, 3, wherein the seat part frame 7, 11 has been moved forward by a seat depth 34. Corresponding to the forward displacement of the seat part frame 7, 11 by the seat depth 34, the connecting frame 8, 12 is pulled along accordingly and the backrest frame 6, 10 has also been accordingly moved downward along the direction in which the backrest frame 6, 10 extends. As can be further seen, the sizes of the variable angles 23, 24 have changed.

Specifically, the angles 23, 24 change in such a way that when the seat is moved forward by a seat depth 34, the first variable angle 23 increases and the second variable angle 24 decreases.

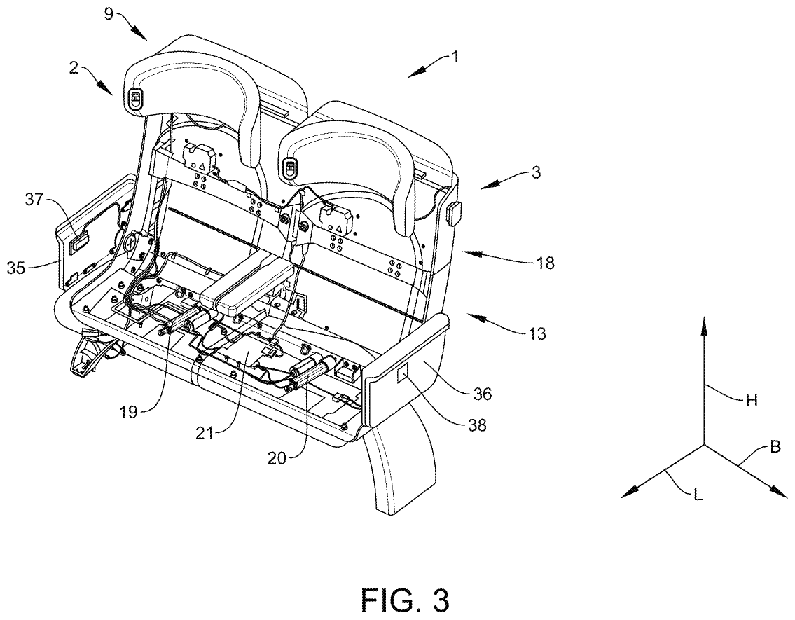

In FIG. 2D, the seat 2, 3 is shown in a sectional view according to FIG. 3C.

In FIG. 3 the seating group 1 is shown with further components. A first adjusting element 19 and a second adjusting element 20 are provided for adjusting or displacing the respective seat part 4, 4′, wherein the first seat part 4 can be displaced by the first adjusting element 19 and the second seat part 4′ can be displaced by the second adjusting element 20.

The first adjusting element 19 is connected to the first seat part frame 7 and the first supporting element 9, and the second adjusting element 20 is connected to the second seat part frame 11 and the second supporting element 13. Preferably, the adjusting elements 19, 20 are arranged below the upholstery element of the seat part 4, 4′.

The adjusting elements 19, 20 can be actuated independently of one another so that the respective seat parts 4, 4′ can be displaced independently of one another.

A control or activation of the adjusting elements 19, 20 is performed by a control unit 21, wherein the first adjusting element 19 and the second adjusting element 20 are connected to the single control unit 21, wherein the control unit 21 is provided and configured to control the adjusting elements 19, 20 independently of each other.

It is particularly preferred that the control unit 21 is arranged below the first seat part frame 7, as seen in the height direction H, and below the second seat part frame 11, as well as between the first adjustment element 19 and the second adjusting element 20, as seen in the width direction B.

To set the respective seat depth, it is provided that the control unit 21 receives control data for actuating the adjusting elements 19, 20 by means of switch elements 37, 38. Preferably, a first switch element 37 is provided. By actuating the first switch element 37, corresponding signals are transmitted to the control unit 21, which then controls the first adjusting element 19. Preferably, a second switch element 38 is provided. By actuating the second switch element 38, corresponding signals are transmitted to the control unit 21, which then controls the second adjustment element 20.

Preferably, a first seat part 35, which is arranged on the side of the first seat 2, and a second seat part 36, which is arranged on the side of the second seat 3, can be provided, wherein the first switch element 37 can be arranged in the first seat part 35 and the second switch element 38 can be arranged in the second seat part 36. Through this, a switch element 37, 38 is assigned to each seat 2, 3 and can be actuated by the respective person sitting on the seat 2, 3.

Accordingly, the switch elements 37, 38, the adjusting elements 19, 20 and the control unit 21 are connected in terms of signals, for example by means of a wiring 40.

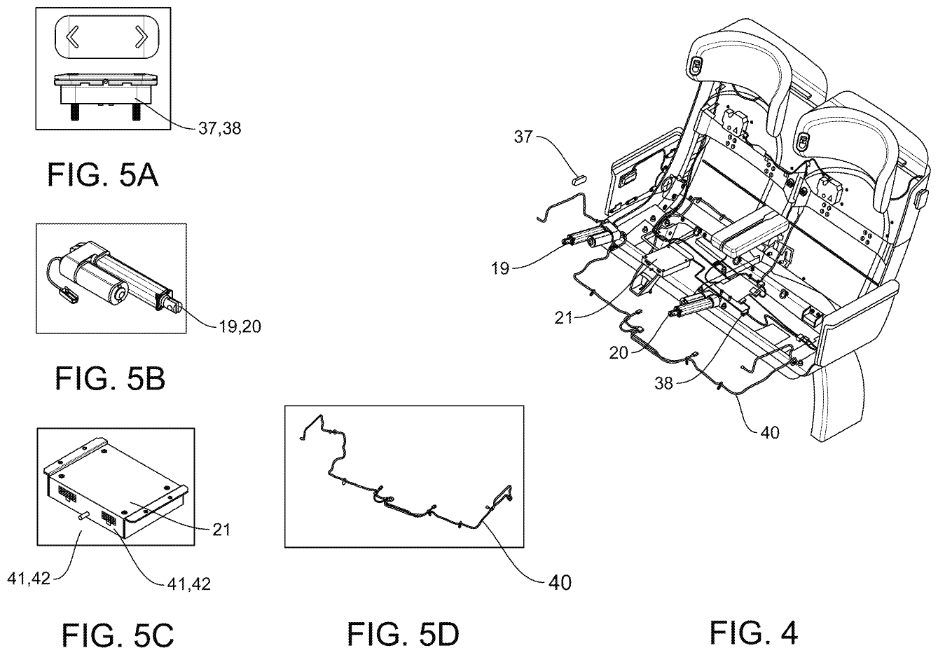

In FIG. 4 the components are shown again in an at least a partial exploded view.

In FIG. 5A, a switch element 37, 38 is shown in a side view or top view. In FIG. 5B, an adjusting element 19, 20 is shown, which can be designed, for example, as a line arm motor or the like. FIG. 5C shows the control unit 21 with corresponding inputs 41 and outputs 42. FIG. 5D again shows the wiring 40 between the switch elements 37, 38, the adjusting elements 19, 20 and the control unit 21.

All features disclosed in the application documents are claimed to be essential to the invention provided that they are new, individually or in combination, compared to the prior art.

All the features listed may be combined with one another in any desired manner.

### LIST OF REFERENCE SIGNS

1 Seating group
2 First seat
3 Second seat
4 Seat part
5 Backrest part
6 First backrest frame
7 First seat part frame
8 First connecting frame
9 First supporting element
10 Second backrest frame
11 Second seat part frame
12 Second connecting frame
13 Second supporting element
14 First rotation axis
15 Second rotation axis
16 Third rotation axis
17 Fourth rotation axis
18 Common supporting element
19 First adjusting element
20 Second adjusting element
21 Control unit
22 Fixed angle
23 First variable angle
24 Second variable angle
25 First backrest section
26 First seat part section
27 Armrest
28 Second backrest section
29 Second seat part section
30 First upholstery element
31 Second upholstery element
32 Third upholstery element
33 Fourth upholstery element
34 Seat depth
35 First seat part
36 Second seat part
37 First switch element
38 Second switch element
40 Wiring
41 Input
42 Output
G Basic position
V Displaced position
K Cabin
L Longitudinal direction
H Height direction
B Width direction
VR Displacement direction

What is claimed is:

1. A seating group comprising a first seat and a second seat which are arranged side by side and are each adjustable in seat depth and lumbar support, each comprising a seat part and a backrest part,
wherein
the first seat and the second seat are each formed and provided for simultaneous adjustment of a seat depth and a lumbar support, the seating group being formed in such a way that the first seat and the second seat can be adjusted independently of one another in relation to the seat depth and lumbar support.

2. The seating group according to claim 1,
wherein
the first seat comprises a first backrest frame, a first seat part frame and a first connecting frame, wherein the first connecting frame is rotatably connected to the first backrest frame via a first rotation axis and rotatably connected to the first seat part frame about a second rotation axis and connecting the first seat part frame to the first backrest frame, wherein the first seat part frame and said first backrest frame are connected to a first supporting element such that said first seat part frame and said first backrest frame are simultaneously displaceable in relation to the first supporting element; and
the second seat comprises a second backrest frame, a second seat part frame and a second connecting frame, wherein the second connecting frame is rotatably connected via a third rotation axis to the second backrest frame and rotatably connected about a fourth rotation axis to the second seat part frame and connecting the second seat part frame to the second backrest frame, wherein the second seat part frame and the second backrest frame are connected to a second supporting element in such a way that the second seat part frame and the second backrest frame are simultaneously displaceable in relation to the second supporting element.

3. The seating group according to claim 2,
wherein
the first supporting element and the second supporting element are rigidly connected to each other so that the first supporting element and the second supporting element form a common supporting element.

4. The seating group according to claim 2,
wherein
the first backrest frame and the first seat part frame are each exclusively translationally displaceable, and the second backrest frame and the second seat part frame are each exclusively translationally displaceable.

5. The seating group according to claim 2,
wherein
a first adjusting element is provided, which is formed to displace the first seat part into a displacement direction, and in that a second adjusting element is provided, which is formed to displace the second seat part in the displacement direction.

6. The seating group according to claim 5,
wherein
the first adjusting element is connected to the first seat part frame and the first supporting element and the second adjusting element is connected to the second seat part frame and the second supporting element.

7. The seating group according to claim 5,
wherein
the first adjusting element and the second adjusting element are connected to a single control unit, the control unit being provided and formed to control the adjusting elements independently of one another.

8. The seating group according to claim 7,
wherein
the control unit is arranged below the first seat part frame and below the second seat part frame and between the first adjusting element and the second adjusting element.

9. The vehicle seat according to claim 1,
wherein
the seat part frame and the backrest frame enclose a fixed and unchangeable angle to each other.

10. The vehicle seat according to claim 1,
wherein
a first variable angle is provided between the seat part frame and the associated connecting frame, and a second variable angle is provided between the associated first backrest frame and the connecting frame, wherein the size of the variable angles changes as the seat part frame is displaced, whereby the lumbar support is variable.

11. The seating group according to claim 3,
wherein
the first backrest frame and the first seat part frame are each exclusively translationally displaceable, and the second backrest frame and the second seat part frame are each exclusively translationally displaceable.

12. The seating group according to claim 3,
wherein
a first adjusting element is provided, which is formed to displace the first seat part into a displacement direction, and in that a second adjusting element is provided, which is formed to displace the second seat part in the displacement direction.

13. The seating group according to claim 4,
wherein
a first adjusting element is provided, which is formed to displace the first seat part into a displacement direction, and in that a second adjusting element is provided, which is formed to displace the second seat part in the displacement direction.

14. The seating group according to claim 6,
wherein
the first adjusting element and the second adjusting element are connected to a single control unit, the control unit being provided and formed to control the adjusting elements independently of one another.

15. The vehicle seat according to claim 2,
wherein
the seat part frame and the backrest frame enclose a fixed and unchangeable angle to each other.

16. The vehicle seat according to claim 3,
wherein
the seat part frame and the backrest frame enclose a fixed and unchangeable angle to each other.

17. The vehicle seat according to claim 4,
wherein
the seat part frame and the backrest frame enclose a fixed and unchangeable angle to each other.

18. The vehicle seat according to claim 5,
wherein
the seat part frame and the backrest frame enclose a fixed and unchangeable angle to each other.

19. The vehicle seat according to claim 6,
wherein
the seat part frame and the backrest frame enclose a fixed and unchangeable angle to each other.

20. The vehicle seat according to claim 7,
wherein
the seat part frame and the backrest frame enclose a fixed and unchangeable angle to each other.
